(19) United States
(12) Patent Application Publication
(10) Pub. No.: US 2013/0018676 A1
(43) Pub. Date: Jan. 17, 2013

(54) SYSTEM AND METHOD FOR PROCESSING DATA RELATED TO A LIFE INSURANCE POLICY HAVING A SECONDARY GUARANTEE

(71) Applicants: Paul M. Fischer, South Windsor, CT (US); Andrew Niedzielski, Wethersfield, CT (US); Gerald G. VanHorn, Tolland, CT (US)

(72) Inventors: Paul M. Fischer, South Windsor, CT (US); Andrew Niedzielski, Wethersfield, CT (US); Gerald G. VanHorn, Tolland, CT (US)

(73) Assignee: HARTFORD FIRE INSURANCE COMPANY, Hartford, CT (US)

(21) Appl. No.: 13/181,963

(22) Filed: Jul. 13, 2011

(51) Int. Cl. G06Q 40/00

(52) U.S. Cl. 705/4

(57) ABSTRACT

A computer system for processing data related to an universal life insurance policy issued by an issuer to an owner and having a death benefit payable to a beneficiary on death of an insured, includes a data storage device storing data indicative of rates and formulas applicable to the policy, and a processor in communication with the data storage device. The processor is configured to: receive data indicative of, for an universal life insurance policy to be illustrated, an age of an insured, a death benefit amount, and timing of payment of premiums; determine an amount of premiums required for the policy by determining whether a policy protection account will have a minimum balance at a selected future date, the policy protection account balance being calculated by crediting to the policy protection account balance amounts of premiums, reduced by a first tier premium charge at a first rate up to a break point amount of premiums, and a second tier premium charge at a second rate above the break point amount of premiums.

### FIELD OF INVENTION

The present invention relates to computer systems, and particularly to computer systems for use in the financial services field, and particularly for processing of data related to life insurance policies.

### BACKGROUND

In the field of life insurance, universal life insurance policies provide for insurance which can continue in force for the entire life of the insured. In contrast, term life insurance policies remain in force only for a specified term of years after issue. In life insurance policies, in general terms, an owner enters into a contract with an issuer, under which the owner pays one or more premiums to the issuer, and the issuer agrees to pay a beneficiary a face value amount upon death of an insured. The owner and the insured are often the same person. The face value amount is much higher than an annual premium, as the death benefit is based on the risk of mortality of the insured. The policies will remain in effect for the entire lifetime of the insured, subject to payment of required premiums. The policies are often purchased initially to replace the income of the insured, with the death benefit being intended to pay for living expenses, tuition and other expenses of children. The policies, when maintained into the retirement years of the owners, serve as a way to pass wealth to children, with immediate payment of death benefits contrasting with the time periods and complications associated with passing assets from an estate to heirs.

Universal life insurance policies, when used as an estate planning vehicle, is often purchased by a single premium paid at issue of the policy. Alternatively, the premium may be paid as level annual premiums over a term of years, such as four years or five years, that is much shorter than the term for which the policy remains in force. The amount of the premium is determined by the issuer based on the amount needed to maintain a policy protection account for a specified period, such as 35 years. A policy protection account is an account used to determine whether the premiums paid are sufficient for the insurance company to obtain sufficient returns on the policy to pay the death benefit and meet operating and other costs. The policy protection account balance is determined based on crediting premiums paid, less charges for cost of insurance and riders. The balance is credited with interest on a periodic basis, at a rate determined at the time of policy issue.

Under a guarantee, termed a secondary guarantee, as long as the policy protection account has a positive balance, the policy will not lapse as a result of an account value insufficient to pay certain monthly deductions, except to the extent the drop in the account value results from policy indebtedness. For a single premium policy, since the formulas and values associated with calculating the policy protection account balance are set at issue of the policy, as long as there are no owner actions, such as policy loans, not anticipated when the premium was determined, the single premium is sufficient to invoke the secondary guarantee. The insurance company does not have the option of seeking additional premiums or allowing the policy to lapse, notwithstanding the lack of account value sufficient to cover the charges. The insurance company, at the time of issue of the policy, must determine a suitable premium to charge to provide sufficient reserves for the policy over a long time period. Accordingly, techniques useful to insurance companies in determining proper premiums are desirable.

### SUMMARY

In an embodiment, a computer system for processing data related to an universal life insurance policy issued by an issuer to an owner and having a death benefit payable to a beneficiary on death of an insured, includes a data storage device storing data indicative of rates and formulas applicable to the policy, and a processor in communication with the data storage device. The processor is configured to: receive data indicative of, for an universal life insurance policy to be illustrated, an age of an insured, a death benefit amount, and timing of payment of premiums; determine an amount of premiums required for the policy by determining whether a policy protection account will have a minimum balance at a selected future date at least 5 years after policy issue, the policy protection account balance being calculated by crediting to the policy protection account balance amounts of premiums, reduced by a first tier premium charge at a first rate up to a break point amount of premiums, and a second tier premium charge at a second rate above the break point amount of premiums, periodically crediting to the policy protection account an interest credit based on a policy protection account balance and an interest rate, and periodically deducting from the policy protection account balance cost of insurance charges based on death benefit amount; generate an illustration for the policy including the determined amount of premiums, face value amount, and insured information, and transmit via a data connection data indicative of the illustration.

In an embodiment, a computer-implemented method for processing data related to an universal life insurance policy having a death benefit payable to a beneficiary on death of an insured, includes: receiving by a processor via a network data indicative of, for an universal life insurance policy to be illustrated, an age of an insured, a death benefit amount, and timing of payment of premiums; accessing by the processor from a data storage device in communication with the processor data indicative of values of rates; determining an amount of premiums required for the policy by determining whether a policy protection account will have a minimum balance at a selected future date at least 5 years after policy issue, the policy protection account balance being calculated by crediting to the policy protection account balance amounts of premiums, reduced by a first tier premium charge at a first rate up to a break point amount of premiums, and a second tier premium charge at a second rate above the break point amount of premiums, periodically crediting to the policy protection account an interest credit based on a policy protection account balance and an interest rate, and periodically deducting from the policy protection account balance cost of insurance charges based on death benefit amount; generating by the processor an illustration for the policy including the determined amount of premiums, face value amount, and insured information, and transmitting by the processor via a data connection data indicative of the illustration.

In an embodiment, a non-transitory computer-readable medium has processor-executable instructions stored thereon, which instructions, when executed by the processor, cause the processor to: receive data indicative of, for an universal life insurance policy to be illustrated, a birth date of an insured, a death benefit amount, and timing of payment of premiums; determine an amount of premiums for the policy by determining whether a policy protection account will have a minimum balance at a selected future date at least 15 years after policy issue, the policy protection account balance being calculated by crediting to the policy protection account balance amounts of premiums, reduced by a first tier premium charge at a first rate up to a break point amount of premiums, and a second tier premium charge at a second rate above the break point amount of premiums, periodically crediting to the policy protection account an interest credit based on a policy protection account balance and an interest rate, and periodically deducting from the policy protection account balance cost of insurance charges based on death benefit amount; generate an illustration for the policy including the determined amount of premiums, face value amount, and insured information, and transmit via a data connection data indicative of the illustration.

In an embodiment, a computer system for processing data related to an universal life insurance policy having a death benefit, includes a data storage device storing data indicative of a policy owner, an insured under the policy, a death benefit amount, payable under the policy to a beneficiary upon death of the insured, a schedule of premium payments, a formula for calculating a policy protection account balance, and values for use in the formula; and a processor in communication with the data storage device, the processor configured to: receive data indicative of an amount of a premium payment received with respect to the policy; access from the data storage device a break point and at least a first rate for a first tier premium charge; determine whether a second tier premium charge at a second rate is applicable to the premium payment; responsive to determining that the second tier premium charge is applicable, determine a charge using the second rate for premium amounts above the break point, and store the calculated credit to the policy protection account in the memory storage device.

### BRIEF DESCRIPTION OF DRAWINGS

FIG. 1 is a schematic diagram of an exemplary computer system for implementation of a method and system of the invention.

FIG. 2 is a schematic diagram of an exemplary computer hardware server with networked devices for implementation of a method and system of the invention.

FIG. 3 is a schematic diagram of an exemplary computer server and process flow diagram for implementation of a method and system of the invention.

FIG. 4 is a view of an exemplary display of data related to an exemplary policy according to an embodiment for a single premium with no difference in rates above and below the break point.

FIG. 5 is a view of an exemplary display of data related to an exemplary policy according to an embodiment for a single premium payment with a higher premium charge for premiums above the break point.

FIG. 6 is a view of an exemplary display of data related to an exemplary policy according to an embodiment for four level premium payments with the same rate for premiums above and below the break point.

FIG. 7 is a view of an exemplary display of data related to an exemplary policy according to an embodiment for four level premium payments with differing rates for premiums above and below the break point.

FIG. 8 is a view of an exemplary display of data related to an exemplary policy according to an embodiment for four level premium payments with the same rate for premiums above and below the break point.

FIG. 9 is a schematic view of an exemplary wireless implementation of a method and system of the invention.

FIG. 10 is an exemplary embodiment of a method and system employing a tablet computer.

FIG. 11 is a graph showing cumulative premiums paid and a break point in an exemplary embodiment.

FIG. 12 is an exemplary screen of an administrator system for administering premium charges in an exemplary embodiment.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for processing of data relating to insurance. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

In a universal life insurance policy, the appropriate pricing for the policy is determined by calculating a balance of a policy protection account, which is also called a shadow account, over a time period, such as 5 years, 10 years, 15, years 20, 25, 30 or 35 years, or a period between any pair of those terms. In a universal life insurance policy with a secondary guarantee, as long as the policy protection account balance is positive, the policy is guaranteed not to lapse even if the account value is depleted as a result of certain periodic charges, such as cost of insurance and rider charges. The policy protection account is typically used only for determination of whether sufficient premiums have been paid, and typically does not represent a balance available to the policy owner.

A challenge faced in connection with setting premiums in universal life insurance policies is in pricing appropriately for changing interest rate environments. The premiums for universal life insurance policies may be paid as a single premium on issue of the policy. For example, a universal life policy may be acquired by an owner or insured at or nearing retirement and wishing to reinvest other assets as a single premium in the policy. In other cases, a universal life insurance policy s premiums are paid over a longer period of time, such as on the basis of level premiums for a multi-year time period, such as a period of 20 years.

In a universal life insurance policy, the appropriate pricing for the policy is determined by calculating a balance of a policy protection account, which is also called a shadow account, over a substantial period, such as 20, 25, 30 or 35 years, or a period between any pair of those terms. In a universal life insurance policy with a secondary guarantee, as long as the policy protection account balance is positive, the policy is guaranteed not to lapse as a result of certain charges. The policy protection account is typically used only for determination of whether sufficient premiums have been paid, and typically does not represent a balance available to the policy owner.

The policy protection account balance is calculated using the following typical criteria. For each premium received, the premium amount, less a regulatory charge and a policy protection premium charge, each based on a percentage of the premium received, is credited to the account. An annual interest amount is credited to the balance of the account. A cost of insurance charge is deducted, and is typically determined based on a rate based on the policy face value or death benefit, such as a certain rate per $1000 of policy face value or death benefit. Other charges may be deducted based on riders applicable to the policy. The rates of charges and credits are set at the issue of the policy. By determining a premium amount, or amounts of multiple premiums, that are sufficient for a sufficient duration, such as 30 years, the issuer can determine a suitable single premium for the policy, or an amount for a series of premiums, using the policy protection account charge factors and the policy protection account interest crediting rate.

In order to provide for sufficient reserves, the insurance company will ordinarily invest the premium amount in long term investments. In principle, long-term investments will provide the greatest return under typical yield curves. The interest rate credited to the policy protection account reflects typical expected investment returns. However, in a low interest rate environment, the returns from long term investment of a large initial premium may not match the desired returns. For policies with premiums paid over many years, the returns on investments may reflect changing prevailing rates, and thus the problem of low returns from investments made near policy issue in a low interest rate environment is ameliorated. The interest rate environment is likely to change over the term of a policy, but reducing the rate credited to the policy protection account balance over the term of the policy is not possible because the rates are guaranteed at issue of the policy.

Similarly, if a policy is issued in a high interest rate environment, a calculated single premium paid at issue may be higher than needed. Accordingly, the charged premium may be uncompetitive with alternatives available to a prospective purchaser of an insurance policy.

In an embodiment, a policy protection account balance is calculated with a first tier premium charge at one rate up to a break point amount of premiums, and a second tier premium charge at a second rate above the break point amount of premiums. The break point amount may apply to premiums paid at issue, in a first year of the policy, or another period of less than about five years from issue. The break point amount may apply to all issues paid under the policy. The second tier premium charge may be different from the first tier premium charge. The second tier premium charge may be greater than the first tier premium charge in a low interest rate environment. The second tier premium charge may be lower than the first tier premium charge in a high interest rate environment. The break point may be selected so that only the first tier premium charge applies to cumulative premiums paid over a selected number of years. The second tier premium charge may apply only to premiums paid at issue and within a window of a selected number of years after issue.

Computer systems for generation of illustrations for universal life policies may be configured to permit a user to change a stored value of a second tier premium charge. Similarly, computer systems for generation of policy documents may be configured to permit a user to change a stored value of a second tier premium charge. By changing a single stored value in one of these systems, the user may adjust the calculations to provide for changes in prevailing interest rates.

In embodiments, a policy protection account may include two, three, or more sections, or a single universal life policy may have more than one policy protection account. For example, premiums may be allocated among the multiple accounts in accordance with a formula set forth in the policy or in a policy protection rider or other policy document. A policy section may only be provided in certain instances in order for an issuing insurance company to meet reserve liability requirements. A break point and second tier premium charge may be applicable only to one section or to one policy protection account. In embodiments, a break point and second tier premium charge may be applicable to more than one account or to more than one section of an account; for example, premiums credited to more than one section or more than one account may be aggregated for purposes of determining whether a break point has been reached.

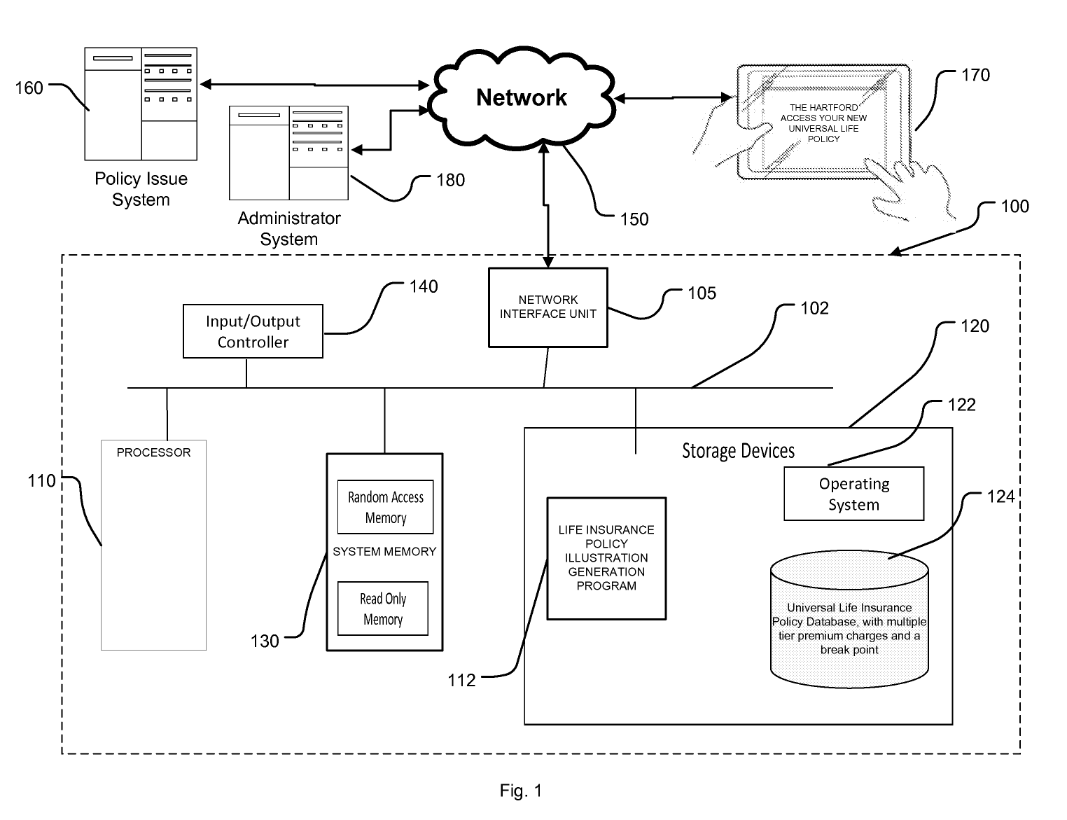

Referring to FIG. 1, an exemplary computer system 100 for use in an implementation of the invention will now be described. In computer system 100, processor 110 executes instructions contained in programs such as universal lie insurance policy illustration application program 112, stored in storage devices 120. Storage devices 120 may include suitable media, such as optical or magnetic disks, fixed disks with magnetic storage (hard drives), tapes accessed by tape drives, and other storage media. Processor 110 communicates, such as through bus 102 and/or other data channels, with network interface unit 105, system memory 130, storage devices 120 and input/output controller 125. Via input/output controller 125, processor 110 may receive data from user inputs such as pointing devices, touch screens, audio inputs and keyboards, and may provide data to outputs, such as data to video drivers for formatting on displays, and data to audio devices. Storage devices 120 are configured to exchange data with processor 110, and may store programs containing processor-executable instructions, and values of variables for use by such programs. Processor 110 is configured to access data from storage devices 120, which may include connecting to storage devices 120 and obtain data or read data from the storage devices, or place data into the storage devices. Storage devices 120 may include local and network accessible mass storage devices. Storage devices 120 may include media for storing operating system 122 and mass storage devices such as policy formula and rate data storage 124 for storing data related to formulas and values of employed in generating illustrations. Such data may include data regarding policies, formulas for calculating policy protection account balances, and other relevant data. It will be appreciated that the data may include values of first tier premium charges, second tier premium charges and a break point value. The system may be configured to provide for alternative rate environments by a user updating a value of a second tier premium charge, for example. In an embodiment, inputs may include user interfaces, including workstations having keyboards, touch screens, pointing devices such as mice, or other user input devices, connected via networked communications to processor 110. Network interface unit 105 may communicate via network 150 with other insurance company computer systems, computer systems of brokers, financial advisors, insureds and owners, remote sources of data, and with systems for implementing instructions output by processor 110. Network 150 may be or include wired or wireless local area networks and wide area networks, and over communications between networks, including over the Internet. Any suitable data and communication protocols may be employed.

Policy issue system 160 connected to system 100 via network 150 is configured to receive policy data consistent with an illustration generated by system 100 and to generate insurance policy documents for issue of insurance policies to owners. Policy issue system 60 may be configured to generate documents, including policy contracts and riders, from stored templates of documents, populated with data, consistent with illustrations generated by system 100, for policies to be issued. Policy issue system 160 may be configured to generate policies after obtaining sufficient information for policy issue prior to comprehensive underwriting, or may be configured to generate documents upon receiving data indicative of completion of comprehensive underwriting. Policy issue system 160 may further be configured to generate binding premium receipts to provide insurance coverage during a period during which comprehensive underwriting is performed. Policy issue system 160 may generate policy documents and issue policies by accomplishing delivery to user-accessible devices, such as tablet computer 170. Tablet computer 170 displays a message advising a user of availability of access of policy documents for a new universal life insurance policy consistent with the illustration generated by system 100. Policy issue system may also generate documents for printing and physical delivery by postal mail to insureds, as well as generating image files for posting to web servers or for access from user accessible devices, such as tablet computer 170.

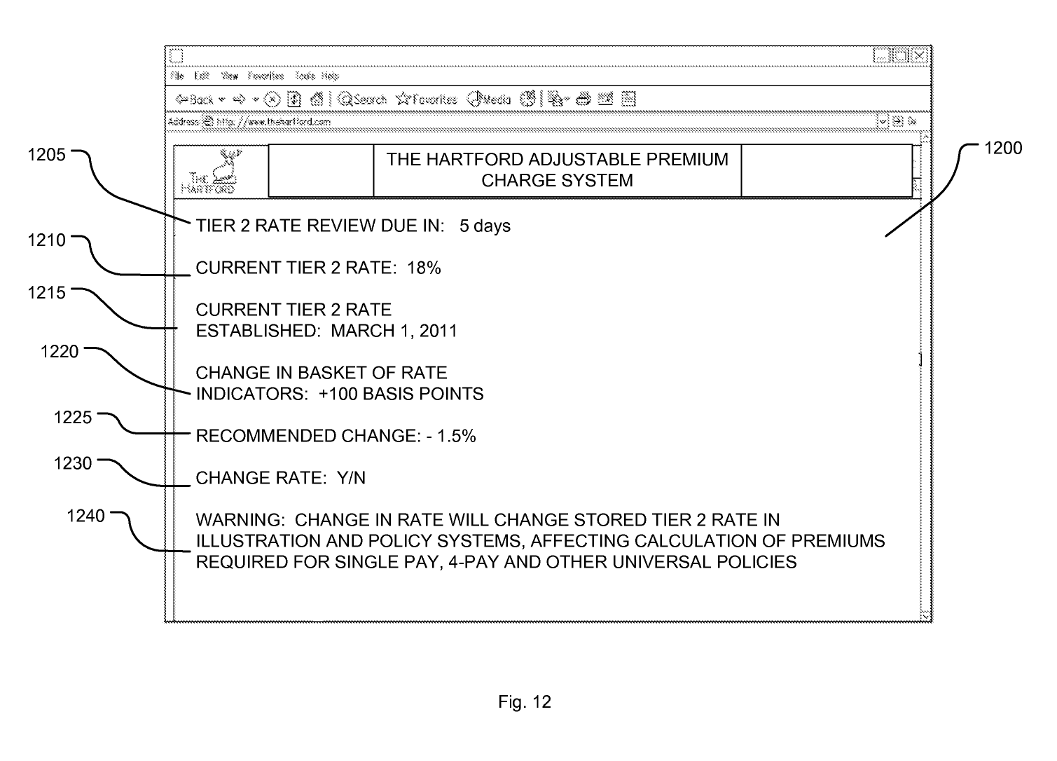

Administrator system 180 is a computer system for administering changes to tier 2 premium charges, and is in communication, via network 150, with systems 100 and 160. Administrator system 180 permits an insurance company administrator to change data in systems 100 and 160 to update tier 2 premium charge rates consistently and concurrently across all of the systems that make use of those rates. An exemplary screen generated by a system such as administrator system 180 is illustrated in FIG. 12 below.

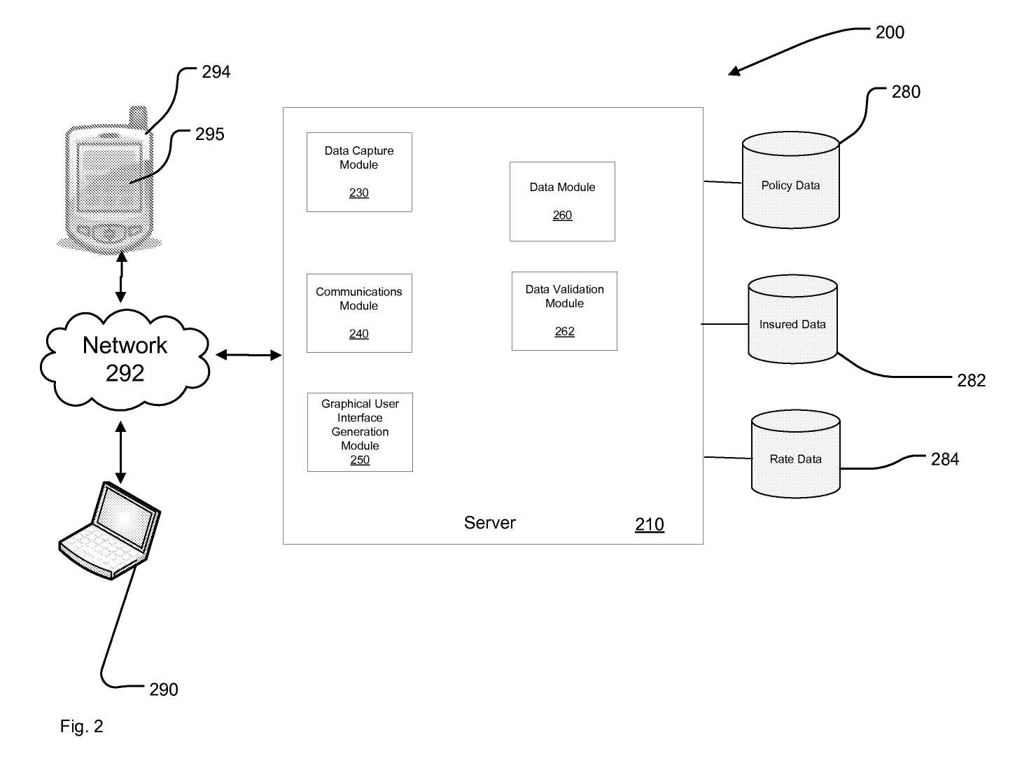

Referring now to FIG. 2, another exemplary embodiment of a system 200 for use in an implementation of the present invention is shown. System 200 includes an insurance company server 210 which includes one or more engines or modules which may be utilized to perform one or more steps or functions of the present invention. In an embodiment, the present invention is implemented as one or more modules of a computer software program in combination with one or more components of hardware. In a system for generating illustrations, such software programs will be used generally where a policy owner, insured, broker or financial advisor or other representative of an insured or owner has sent a request for data or information to a server and comprises part of the processing done on the server side of the network. In a system for generating policy documents, such software programs will be used, for example, when an application for insurance has been approved after underwriting and receipt of premium. The program may be used in an Internet environment, where the server is a Web server and the request is formatted using HTTP (or HTTPS). Alternatively, the server may be in a corporate intranet, and extranet, or any other type of network. Use of the term Internet herein, when discussing processing associated with the user's request, includes these other network environments, unless otherwise stated. Additionally, a graphical user interface or insurance processing module may be implemented as an intelligent hardware component incorporating circuitry comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of a web client or other module may be implemented as application software in the form of a set of processor-executable instructions stored in a memory of a client device, such as smart phone 294, and capable of being accessed and executed by a processor of the client device.

Referring still to FIG. 2, server 210 includes a data capture or input/output module 230, a communications module 240, a dynamic display generation or graphical user interface module 250, a data module 260, a data validation module 262. Data module 260 is in further communication with a number of databases such as insurance policy database 280, insured database 282 and document database 284. Databases in communication with server 210 may include both internal and/or external/third party databases. By way of example, external databases may include databases of brokers or others having information relating to insureds and applicants for insurance, such as names, ages, names and ages of children and other possible beneficiaries, and the like. Server 210 may be configured for bulk upload of data for use in administration of insurance policies, such as data relating to insureds, from a third party database or file. One or more modules may be configured to perform data validation steps prior to storing bulk uploaded data. Server 210 may further be configured to permit bulk download of data, such as policy and benefit data, to a client device.

In operation, server 210 is in communication with client devices, such as computer 290 or smart phone 294, via a network which facilitates interaction with server 210 through one or more graphical user interfaces as shown and described herein. As used herein, devices, such as client devices 290, 294 may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Referring still to FIG. 2, utilizing client devices 290, 294, a properly authenticated system user, such as a policy owner or a financial advisor of a policy owner, may request an illustration for a universal life insurance policy. A properly authenticated system user may provide data to an illustration system for generation of illustrations of universal life policies, including calculation of policy protection account balances and premium amounts using first and second tier premium charges, using a user interface 295 on smart phone 294, for example. A properly authenticated system user in an administrative capacity may also access data and formulas and, for example, update second tier premium charge rates and update policy related documents to reflect changes in second tier premium charge rates. Other policy-related documents, such as riders, policies, contracts, and illustrations may be stored as data. These documents may be maintained in memory as image files, for example, and available for download and viewing on client devices 290, 294. A properly authenticated individual responsible for administration of policies may access further data. In embodiments of the present invention, one or more of the above modules, such as graphical user interface module 250, data module 260 and data validation module 262 may also be implemented in combinations of software and hardware for execution by various types of computer processors coupled to such hardware.

As used herein, a module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, comprise the module and achieve the stated purpose for the module such as implementing the business rules logic prescribed by the present system. In the present invention a module of executable code may be a compilation of many instructions, and may even be distributed over several different code partitions or segments, among different programs, and across several devices. Similarly, data, including by way of example policy data, insured data and investment data may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

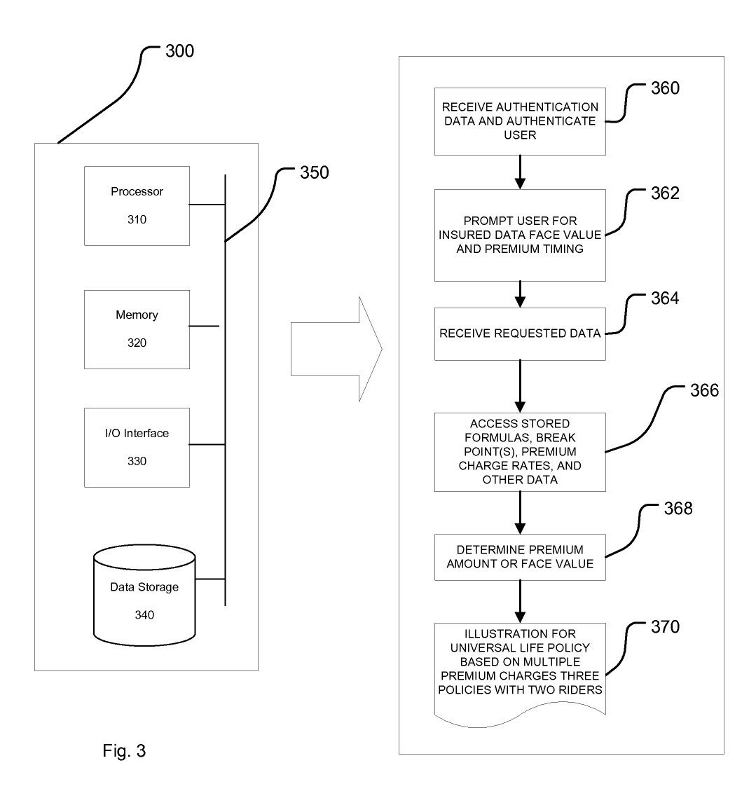

Referring to FIG. 3, in an embodiment, a computer server or client computer 300 running a client application such as a Web browser or a thick client application renders a graphical user interface, such as a series of input screens for viewing and input from a prospective insured, broker, financial adviser, applicant for insurance or other persons. Server or client computer 300 may include a processor 310, e.g. CPU, memory 320, I/O interface 330 and a storage mechanism 340 coupled together via a system bus 350 over which the various elements may interchange data and information. Computer 300 implements steps 360-374 in accordance with embodiments of the present invention.

Still referring to FIG. 3, computer 300 receives 360 authentication information from an authorized user, such as a prospective insured or broker or other financial adviser acting on behalf of a prospective insured or policy owner, employing a user-accessible device, and authenticates the user. The system prompts 362 the user for data needed to generate an illustration; the system may generate screens to request data from the prospective insured, such as names, ages and genders of insureds and beneficiaries. The system may further prompt the user to input requested face amount of a policy, type of premium arrangement, such as single premium, three premiums in first three years of policy, or level 20 year premium. The system receives 364 the requested data from the user-accessible device. The system may determine 368, by accessing from data storage 340, formulas and values of formula variables, including first and second tier premium charges and a break point, the premium corresponding to the requested face value amount.

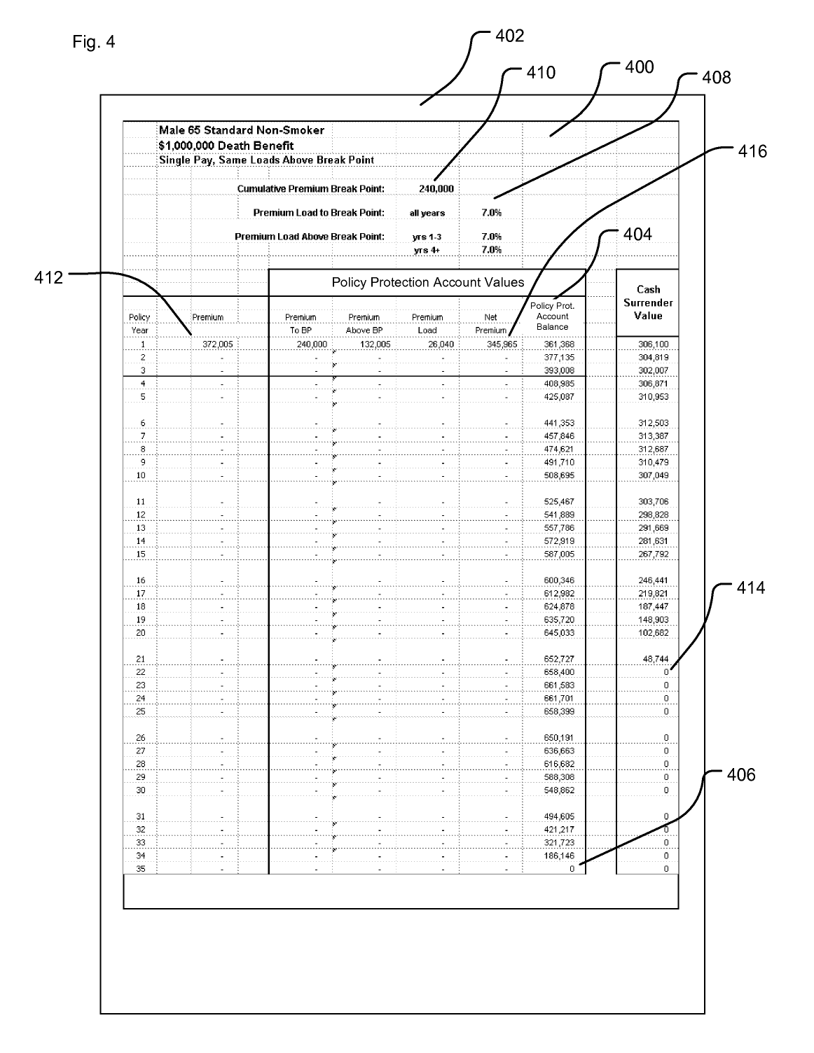

FIG. 4 is a view of an exemplary display of data related to an exemplary policy according to an embodiment for a single premium with no difference in rates above and below the break point. Display 400 on device 402 illustrates a universal life insurance policy for an insured male, age 65 at policy issue, with a face value of $1,000,000, paid via a single premium. A 35 year projection 404 of the policy protection account value is shown, going to the minimum account value of zero 406 at the end of the selected time period of 35 years, which is age 100 for the insured. The first tier premium charge and second tier premium charge are both 7%, as shown at 408. The break point is $240,000, as shown at 410. The premium sufficient to provide the policy protection account value of at least zero at 35 years from policy issue, which is age 100 for the insured, is $372,005, as shown at 412. The cash surrender value declines to zero at year 22 of the policy, as shown at 414, but the policy remains in force as a result of the secondary guarantee, despite the lack of new premiums or any account value to charge for cost of insurance and administrative charges.

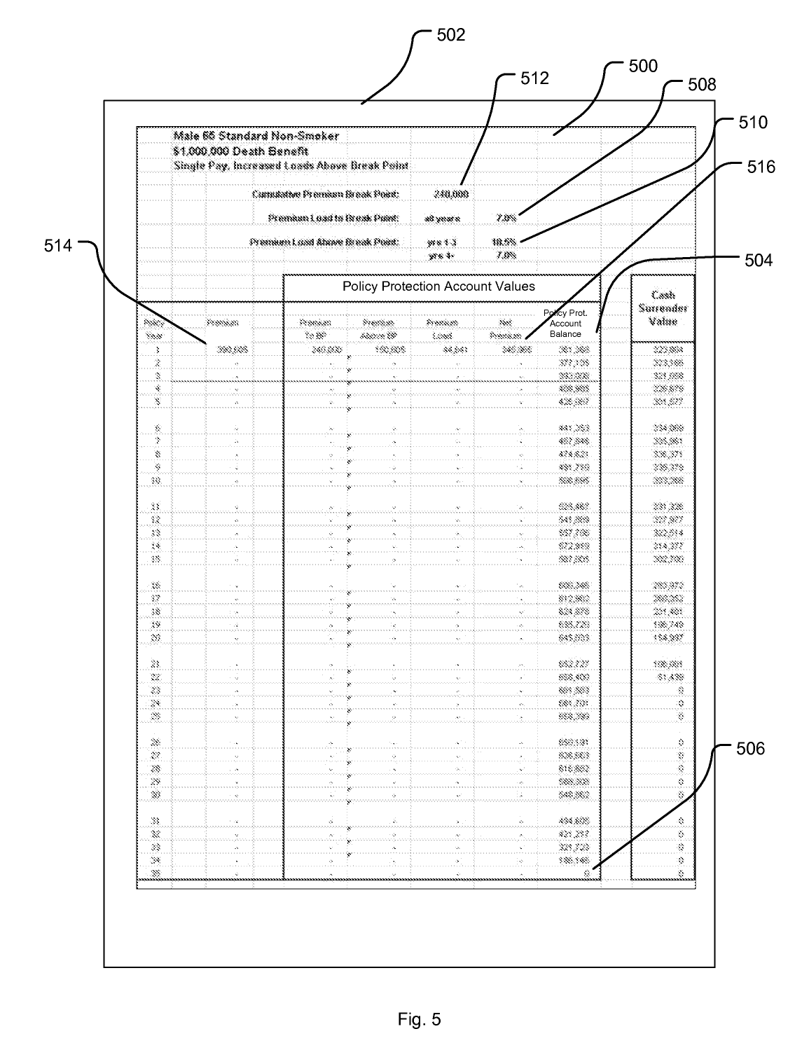

FIG. 5 is a view of an exemplary display of data related to an exemplary policy according to an embodiment for a single premium with a higher premium charge for premiums above the break point. Display 500 on device 502 illustrates a universal life insurance policy for an insured male, age 65 at policy issue, with a face value of $1,000,000, paid via a single premium. A 35 year projection 504 of the policy protection account value is shown, going to the minimum account value of zero 506 at the end of the selected time period of 35 years. The first tier premium charge is 7%, shown at 508. The second tier premium charge is 18.5% for premiums received in the first three years, as shown at 510. The break point is $240,000, as shown at 512. The premium sufficient to provide the policy protection account value of at least zero at 35 years is $390,605, as shown at 514. The higher premium, as compared with the example of FIG. 4, is appropriate for single pay policies in a low interest environment at the time of policy issue. In both the example of FIG. 4 and the example of FIG. 5, the net premium applied to the policy protection account balance is the same, $345,965, as shown at 416 in FIGS. 4 and 516 in FIG. 5.

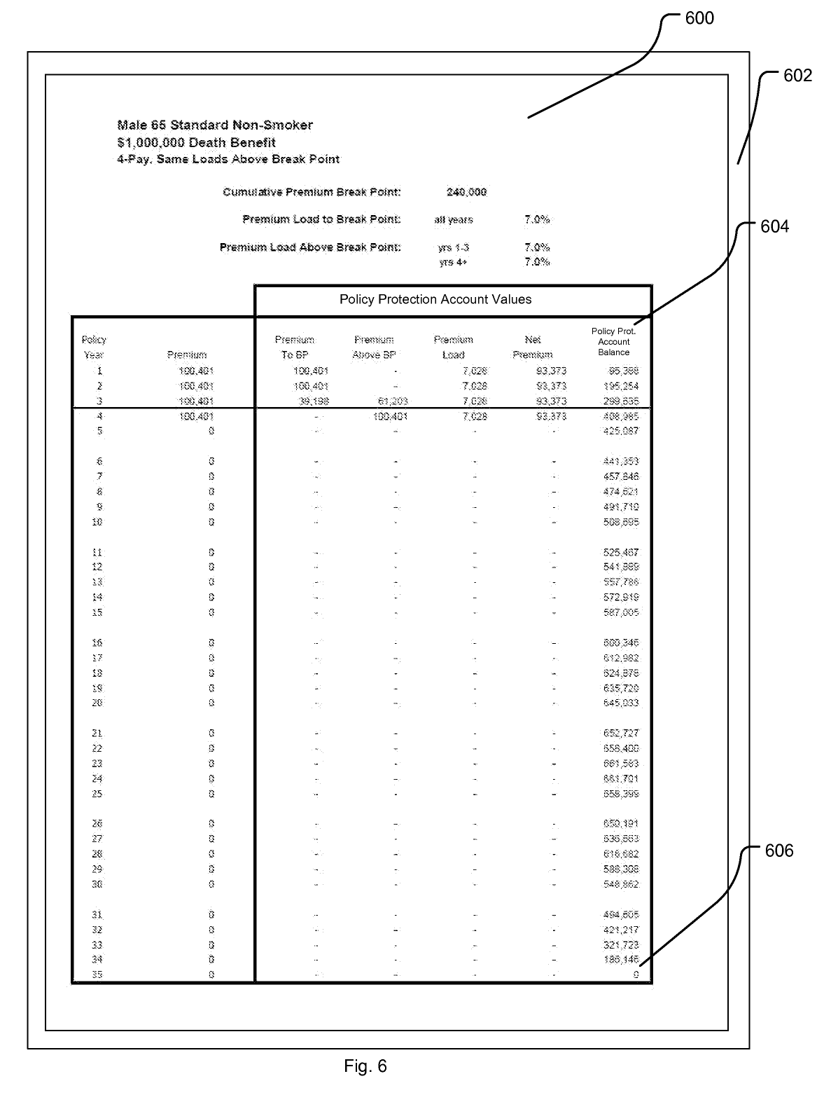

FIG. 6 is a view of an exemplary display of data related to an exemplary policy according to an embodiment for a premium paid in four level annual installments with no difference in rates above and below the break point. Display 600 on device 602 illustrates a universal life insurance policy for an insured male, age 65 at policy issue, with a face value of $1,000,000, paid via four level annual premiums. A 35 year projection 604 of the policy protection account value is shown, going to the minimum account value of zero at the end of the selected time period of 35 years. The first tier premium charge and second tier premium charge are both 7%, as shown at. The break point is $240,000. The premium payments sufficient to provide a policy protection account value of $408,985 at the fourth policy anniversary. The policy protection account value exceeds the premiums credited to the policy protection account because the interest credited to the policy protection account balance exceeds the charges deducted from the balance. The policy protection account value of $408,985 at the fourth policy anniversary is sufficient to provide a balance that does not reach zero until 35 years after policy issue. Four level annual premium payments of $100,401 are sufficient to provide the desired policy protection account balance. The value of $408,985 is only exemplary, and is based on a number of factors, including the interest rate credited to the policy protection account balance under the contract, the face value amount, the cost of insurance rates charged against the policy protection account, the cost of riders charged against the policy protection account, and other charges. For example, for a higher interest rate credited to the policy protection account balance under the contract, a lower policy protection account balance at the fourth year anniversary would be required to maintain a positive balance until the end of the 35 year period, and hence lower premium payments would be required, if no other change were made to the policy.

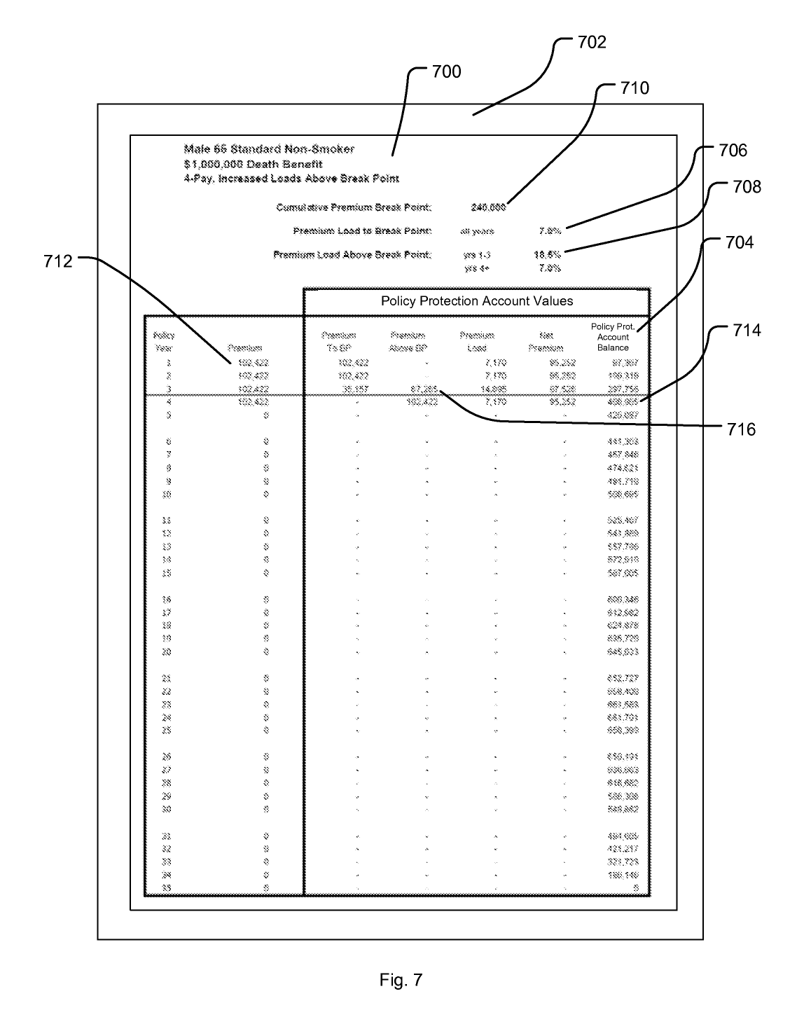

FIG. 7 is a view of an exemplary display of data related to an exemplary policy according to an embodiment for four level annual premiums with a higher premium charge for premiums above the break point. Display 700 on device 702 illustrates a universal life insurance policy for an insured male, age 65 at policy issue, with a face value of $1,000,000, paid via four level annual premiums. A 35 year projection of the policy protection account value is shown at 704, going to the minimum account value of zero at the end of the selected time period of 35 years. The first tier premium charge rate, at 706, is 7%, and the second tier premium charge rate, at 708, is 18.5% for premiums received in policy years 1 through 3, i.e., before the third anniversary of policy issue. The break point 710 is $240,000. The premium payments sufficient to provide the shadow account value of at least zero at 35 years, and to provide a policy protection account balance of $408,985 at the fourth anniversary of the policy 714, are four level annual payments of $102,422, shown at 712. The second tier premium charge rate has a minor effect, as none of the year 1 and year 2 premiums, and only $67,265 of the year 3 premium, shown at 716, is subject to the higher rate. Accordingly, the difference in each premium payment, as compared to the example of FIG. 6, is only $1,021.

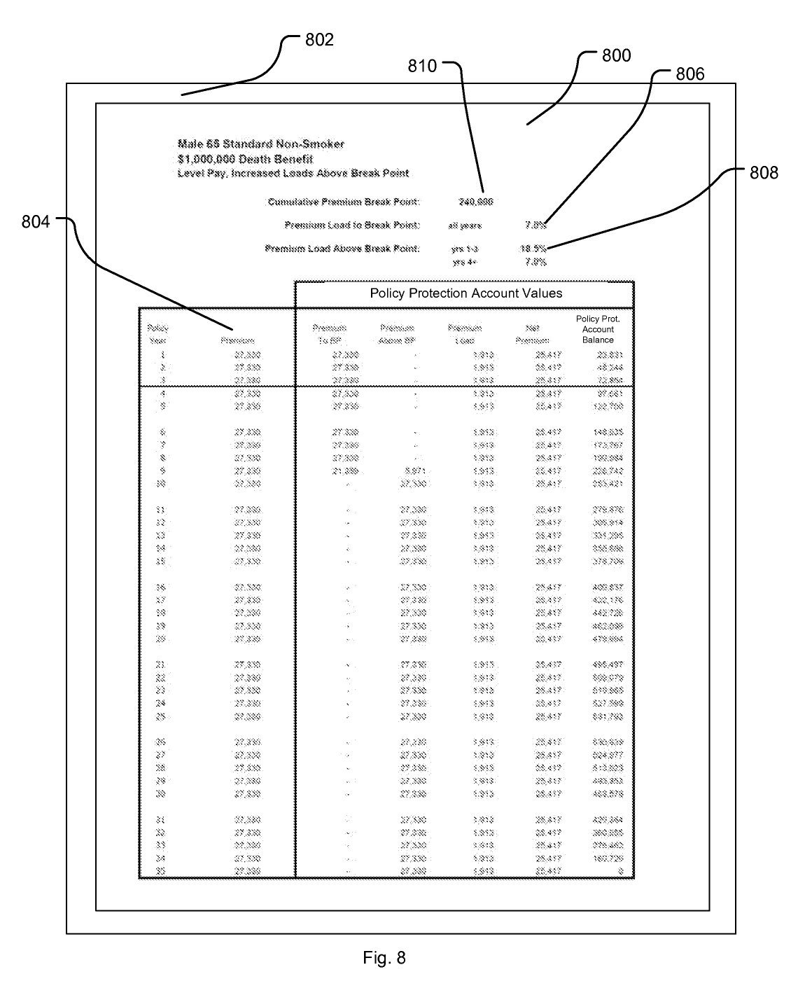

FIG. 8 is a view of an exemplary display 800 on device 802 of data related to an exemplary policy according to an embodiment for 35 level annual premiums 804 with a higher premium charge for premiums above the break point. Display 800 illustrates a universal life insurance policy for an insured male, age 65 at policy issue, with a face value of $1,000,000, paid via 35 level annual premiums. A 35 year projection of the policy protection account, value is shown, going to the minimum account value of zero at the end of the selected time period of 35 years. The first tier premium charge rate 806 is 7%, and the second tier premium charge rate 808 is 18.5% for premiums received in policy years 1 through 3, i.e., before the third anniversary of policy issue. The break point 810 is $240,000. As the break point is not reached, the second tier premium charge is not applicable. As the premiums are received annually, the issuing insurance company is not at risk of being locked in to low yield investment of a single premium received at policy issue, if the policy is issued during a period of low interest rates, or a four pay or similar premium received within a few years after policy issue, and so there is no need to apply the second tier premium charge. The annual premium amount needed to provide a positive policy protection account value until 35 years from policy issue is $27,330.

It will be appreciated that the values shown in FIGS. 4-8 are exemplary only. By way of example, the policy protection account value of $408,985 at fourth policy anniversary is only exemplary, and is based on a number of factors, including the interest rate credited to the policy protection account balance under the contract, the face value amount, the cost of insurance rates charged against the policy protection account, the cost of riders charged against the policy protection account, and other charges. For example, for a higher interest rate credited to the policy protection account balance under the contract, a lower policy protection account balance at the fourth year anniversary would be required to maintain a positive balance until the end of the 35 year period, and hence lower premium payments would be required, if no other change were made to the policy. The first tier and second tier premium charges shown are also exemplary. Indeed, an issuing insurance company will likely review and change the second tier premium charge on a periodic basis, such as on a period of from one calendar quarter to two years. The second tier premium charge being equal to or higher than the first tier premium charge is also only exemplary. In an interest rate environment regarded as an unusually high rate period, the second tier premium charge will be lower than the first tier premium charge.

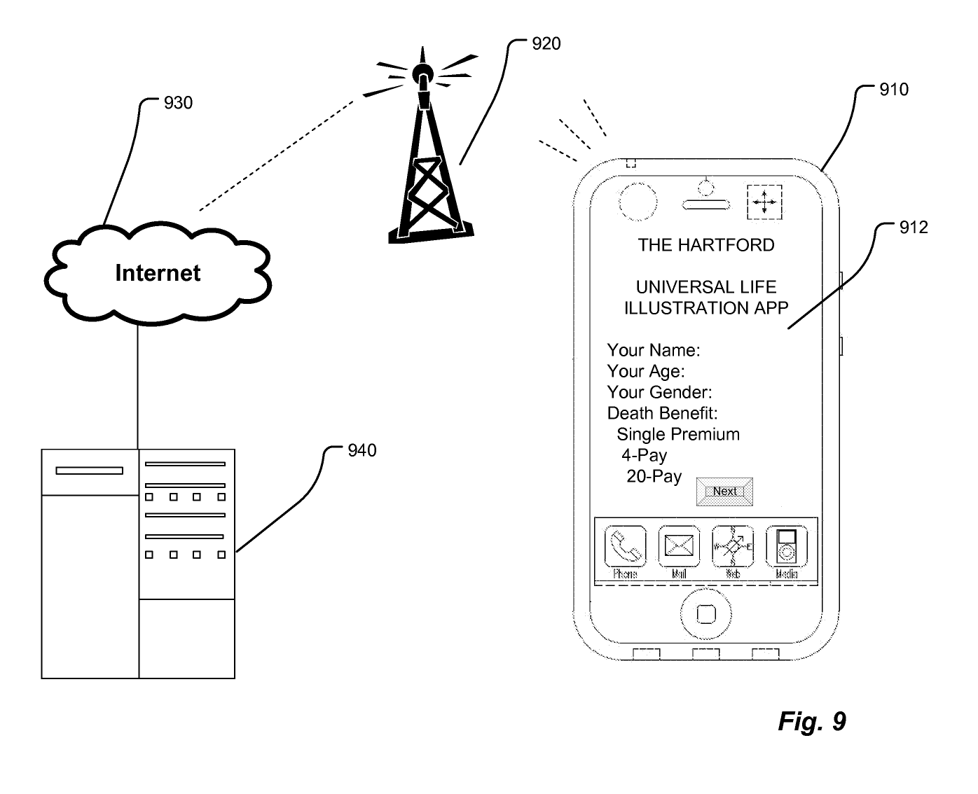

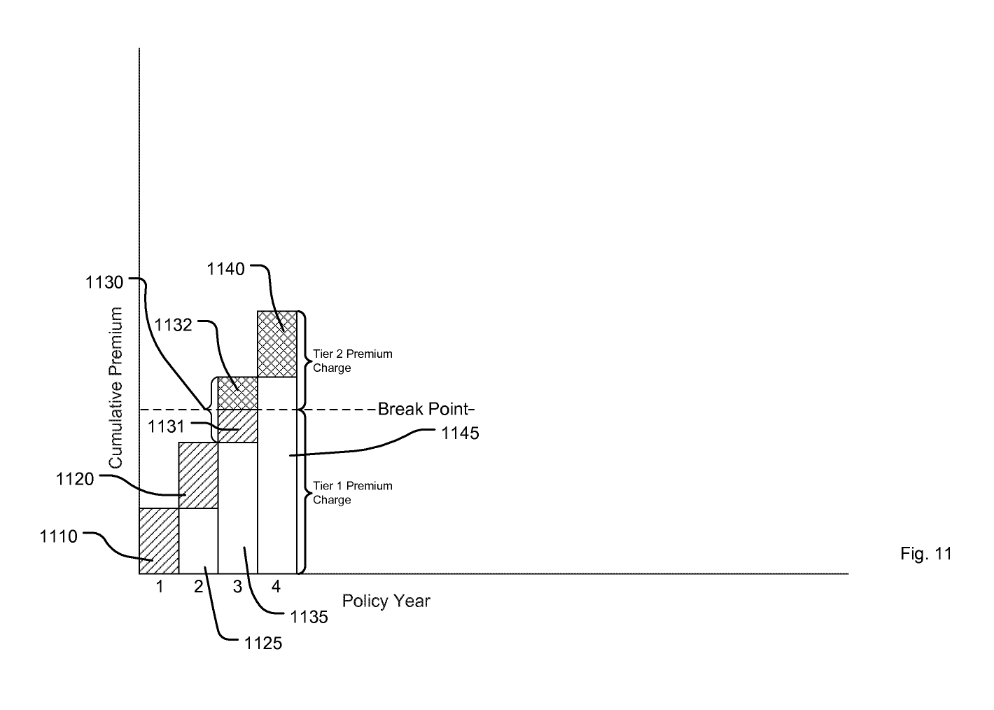

Referring to FIG. 9, a network is illustrated including a wireless device for providing a user interface for receiving instructions, prompting a user and displaying illustrations and policy documents in connection with universal life insurance policies having premium charges based on at least two tiers of rates above and below a break point. Hardware server 940 is an exemplary computer system, such as an insurance company computer system. Hardware server 940 may include a processor and devices in communication with the processor via a bus, the devices including data storage devices, communications devices, user interfaces, and other devices. Hardware server 940 may be configured, such as through processor-executable instructions stored as program code in one or more of the data storage devices, to provide the functionality of a computer system for processing data related to universal life insurance policies and illustrations for such policies having first and second tier premium charge rates above and below a break point. Hardware server 940 is in communication, via network 930, which may include one or more local area networks, wide area networks and interconnected networks (including the Internet), with a wireless communications network, represented by antenna 920. The wireless communications network may be a wireless telephone communications network for transmission of voice and data to and from mobile wireless devices, such as cellular telephones, smart phones and computers. Handheld wireless communications device 910 is in wireless communication with the wireless communications network via antenna 920. Handheld wireless communications device may be any device capable of bidirectional wireless communications via cellular telephone networks, wi-fi devices, two-way radio, or any other form of wireless communications. Handheld wireless communications device 910 may be a cellular telephone, smart phone, personal digital assistant, tablet computer, notebook computer, or other type of wireless communications device with a display and processing capability. Via handheld wireless communications device 910, a user may generate illustrations as discussed above, with reference to FIG. 11, apply for life insurance policies as discussed above, receive policy documents, including illustrations, binders, policies, and statements, authorize electronic payments of premiums, receive statements including calculations of applications of premiums to policy protection accounts, and other documents.

In an embodiment, handheld wireless communications device 910 may include a processor and memory device or memory devices in communication with the processor, as well as wireless antenna assemblies and one or more displays, such as touch screen displays, in communication with the processor. In an embodiment, a memory device of handheld wireless communications device 910 has stored therein an application program including processor executable instructions for prompting a user to provide insured information, death benefit amount information, and premium timing selection, receiving the information, and generating illustrations, as discussed above. The application program may generate display 912 to prompt the user to input data. The application program may retrieve rate and other data information via server 940 and may display illustrations. In an embodiment, the device 910 is configured to generate illustrations, and to receive premium payments and provide statements. Any steps described in the present application as being performed by a server-based or other insurance company computer system, by way of example, may be performed, in whole or in part, by a processor of a handheld device executing instructions stored in a non-transitory computer-readable medium of the handheld device.

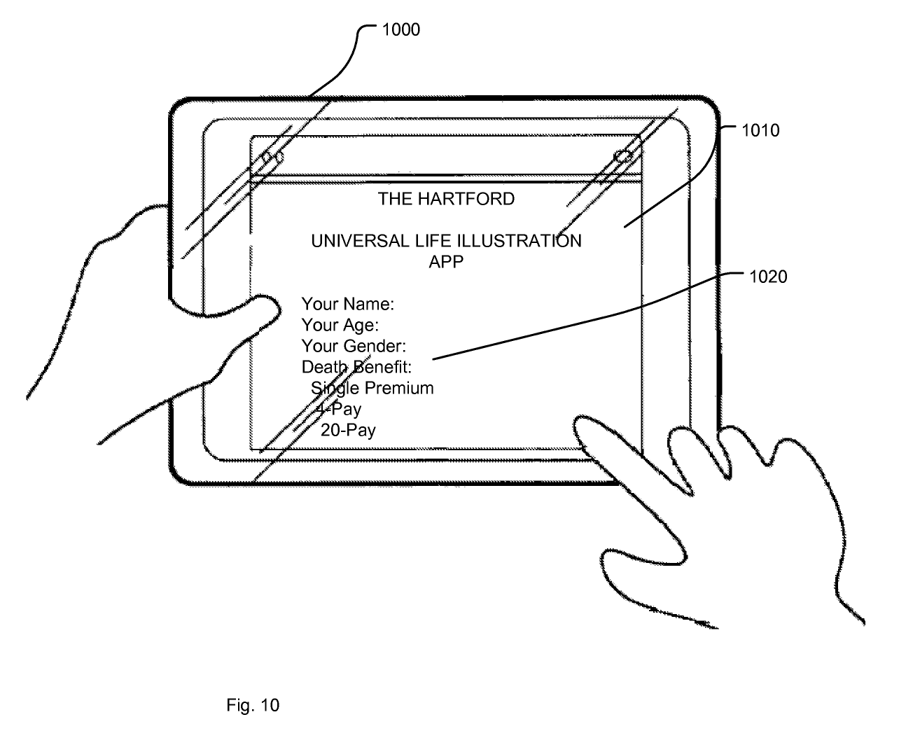

In FIG. 10, a tablet computer 1000 is shown illustrating a screen 1010 from an application for prompting the user to supply data 1020, such as insured age and gender data, desired death benefit amount and the like, for generation of an illustration of a universal life insurance policy with at least two rates of premium charges applied above and below a break point of premium amounts. Tablet computer 1000 may be configured to generate an illustration, and may be in wireless communication with a server and other computer system for generation of illustrations, generation of policy documents, and administration of insurance policies. Tablet computer 1000 may be configured to be accessed by an administrator computer, such as administrator computer system 180 of FIG. 1, for updating of data, such as a second rate corresponding to a second tier premium charge, stored in a memory device of tablet computer 1000, and used by tablet computer 1000 in generating policy illustrations.

Referring to FIG. 11, a bar chart is provided showing four annual premiums relative to a break point. For year 1 premium 1110, the cumulative premiums are less than the break point 1150. Accordingly, the entire year 1 premium 1110 is subject to the tier 1 premium charge, as shown by the diagonal hashes. For year 2 premium 1120, shown on cumulative prior premiums 1125, cumulative premiums are also below the break point, and thus the entire year 2 premium 1120 is subject to the tier 1 premium charge. For year 3 premium 1130, shown on cumulative prior premiums 1135, a first portion 1131 of the premium is below the break point, and a second portion 1132 of the premium, shown by cross-hatching, is above the break point and thus subject to the tier 2 premium charge. For year 4 premium 1140, the entire premium is above the break point and thus subject to the tier 2 premium charge.

Referring to FIG. 12, a screen is illustrated of an exemplary system for use by a system administrator in setting tier 2 premium charge rates. Screen 1200 is of a system that is in communication with both illustration and policy generation systems, and is configured for simultaneously updated memory locations storing tier 2 premium charge rates for use in both illustrations and policy documents. Screen 1200 displays a timing 1205 to a next maximum tier 2 rate review. For example, the system may be configured to review automatically, based on interest rate data accessed from local and networked data, the tier 2 rate, and/or to prompt users to perform a manual review, or a manual determination based on system recommendations. The frequency may be, for example, monthly, calendar quarterly, semi-annually, annually or another time period. The screen 1200 displays a current tier 2 rate 1210 accessed from the system memory storage devices. The system also accesses data indicative of the date the current tier 2 rate was set and displays the date 1215. The date set is useful to an administrator in determining whether a review or change is currently required, such as due to changes in the interest rate environment. The system displays a change in a basket of rate indicators 1220 subsequent to the date 1215 to assist a user in deciding whether to change or re-evaluate the tier 2 rate. The system generates, based on current rate data and one or more algorithms correlating current market rate data to tier 2 rate data, a recommended change 1225 in the tier 2 rate. The accessed rate data may be selected from among many sources, and may be weighted to current long term interest rates, to rates that are correlated with changes in long term interest rates, and to other sources of data. In this example, as the basket rate has increased, the recommended change is a decrease in the tier 2 rate. In general, algorithms for recommended rates will provide a result indicating a change which is opposite to the change in a basket of long-term (i.e., rates on instruments maturing in terms of at least one year) interest rates. The user is presented an option at 1230 to change or not change the tier 2 rate. The system displays warning 1240 that changing the rate on the system will result in a change in data in illustration and policy generation systems indicative of tier 2 premium charges.

The system may determine the current policy protection account value using an algorithm represented by stored data. The algorithm may be, by way of example: (Prior policy protection account value)+((Premiums paid subsequent to date of prior policy protection account value)×(1−(Percentage deducted from premiums))+((Prior policy protection account face value)×(credited interest rate)) ‘((Face Value)×(percentage charge for period))’ (rider charges for period)−(Amount of withdrawals from policy)’ (Amount of loans from policy)+(Amount of loan repayments). The period may be a year, or another time period, such as a calendar quarter or month. For illustrations, the assumption will typically be that there are no withdrawals, loans or loan repayments. However, an illustration may be generated to provide for withdrawals, loans and loan repayments. For example, a prospective insured may request that an illustration include a loan to provide for an anticipated future large expense, such as a grandchilds college tuition, a purchase of a vacation home, or other large expense, with a schedule for loan repayment. Similarly, a prospective insured may request that one or more withdrawals be included in the illustration.

Communications to prospective insureds, insureds, owners and beneficiaries may be dispatched in any suitable manner. By way of example, a printing and mailing system may print on paper and dispatch by postal mail a statement or letter enclosing an illustration, providing a statement of application of premium amounts to policy protection accounts, or other data. The communication may be provided as data for display on a wireless device, such as handheld wireless communications device 910.

In an embodiment, the system is configured to solve directly for a premium amount that will result in a positive policy protection account balance for the entire period (e.g., until insured age 100, 35 years from policy issue, or other age or time period) based on given premium load rates, break point, credited interest rate, and charges against the policy protection account. The system may be configured to iteratively test increased periodic premium amounts until an amount is obtained that is sufficient to provide the minimum policy protection account balance by end of the period of interest, such as the end of the 35 year period in the illustrations of FIGS. 4-8. The system selects an initial premium amount. The initial amount may be accessed from a stored table. If the premium is determined to be insufficient, an increased amount may be determined by increasing each scheduled premium payment by a percentage, such as 1%, or by increasing each scheduled premium payment by a dollar value, such as $100. The system then determines the predicted policy protection account balance as of the desired date using the increased periodic premium amount. The predicted policy protection account balance may be determined by iteratively adding portions of scheduled premiums to the current balance, and deducting charges, as explained above. The predicted shadow balance obtained using the increased periodic premium amount is then compared to the minimum policy protection account balance. If the predicted policy protection account balance obtained using the increased periodic premium amount is less than the minimum policy protection account balance, then the process flow returns to the step of selecting an increased periodic premium amount.

While examples have been provided having one break point and corresponding first and second rates, in other embodiments, a second break point, higher than the first break point, may be provided and a corresponding third rate of premium charges, may be applied to premiums above the second break point. Similarly, additional break points and rates may be provided. In embodiments, rather than or in addition to changing a rate in response to a change in interest rate environments, a break point value may be changed. In embodiments, rather than applying break points to cumulative premiums, break points and corresponding second rates may be applied to premiums received in a period of one year, two years, or a period of different duration. In embodiments, differing break points and differing rates may be applied to different periods in the same policy or illustration.

A policy or a policy protection rider of a policy may provide that the policy protection account serves as a reference account used solely to determine whether or not the policy protection test has been met. The policy protection test determines whether the policy protection benefit is available. The policy protection benefit is also referred to as the secondary guarantee. The policy protection benefit provides that the policy does not lapse due to payment of certain charges, such as cost of insurance charges, even if the account value is not sufficient to pay the charges. The account may consists of two sections, Section A and Section B. It is not used to determine the actual account value, cash value, cash surrender value or death benefit provided by the policy.

The policy protection account monthly charge may be deducted on a periodic basis, such as monthly on a monthly activity date, from the Policy Protection Account.

Policy Protection Net Premium: the premium amount credited to the Policy Protection Account. It is the premium paid into the Policy minus deductions for the Policy Protection Premium Charge and the Policy Protection Regulatory Charge.

Policy Protection Premium Charge: a charge deducted from premiums paid. It is calculated by multiplying premium paid by the applicable percentage as shown in the Policy Protection Rider Specifications Pages.

Policy Protection Regulatory Charge: a charge deducted from premiums paid. It is calculated by multiplying the premium paid by the applicable percentage as shown in the Policy Protection Rider Specifications Pages.

The Policy Protection Rider benefit, if available, will prevent the owner s Policy from going into default, on any Monthly Activity Date, when the Account Value is not sufficient to cover the Monthly Deduction Amount. If this benefit goes into effect (a) any Monthly Deduction Amounts (attributable to the coverage(s) protected by the Policy Protection Rider benefit) that exceed the Account Value, less Indebtedness, will be waived, and (b) any riders as shown in the Policy Protection Rider Specifications Pages as being protected by this Policy Protection Rider benefit, will continue subject to the terms and conditions of the riders. However, this benefit will not prevent the owner s Policy from going into default when the Indebtedness equals or exceeds the Cash Value. Please refer to the Policy s Termination Due To Excessive Indebtedness provision for more information.

This benefit is available if, on any given Monthly Activity Date, the Policy Protection Test is met. If this benefit is not available, it can be made available at any time by making a premium payment or loan repayment, sufficient to meet the Policy Protection Test. However, if premiums received to restore the availability of this benefit would cause the policy to fail to meet the definition of life insurance (in accordance with the Internal Revenue Code) the excess premiums will be refunded and this benefit will not be available at that time.

The Policy Protection Test is met if the accumulated value in the Policy Protection Account is equal to or greater than zero. If the test is not met, the benefit will not be available.

This benefit will go into effect when the Account Value of the owner s Policy is insufficient to cover the Monthly Deduction Amount provided that the Policy Protection Test is met.

The accumulated value in the Policy Protection Account equals the sum of the accumulated values in Section A and Section B. On the Policy Date, the accumulated value in Section B equals the Policy Protection Net Premium and the accumulated value in Section A equals zero.

On each subsequent Monthly Activity Date, the accumulated value in Sections A and B equals: the accumulated value in the Section on the previous Monthly Activity Date; plus any Policy Protection Net Premium allocated to that Section since the last Monthly Activity Date; plus interest credited at the Section s policy protection credited rate (as shown in the Policy Specifications) since the last Monthly Activity Date; minus the appropriate Policy Protection Monthly Charge taken from the Section on that date (see below); minus any Withdrawals taken from the Section since the last Monthly Activity Date; minus any loans taken from the Section since the last Monthly Activity Date; plus any loan repayments to the Section since the last Monthly Activity Date, Any other adjustment made to the Policy s Account Value will impact the accumulated values in the Policy Protection Account in the same manner.

During the first Policy Year, all premium payments and loan repayments are allocated to Section B of the Policy Protection Account. On the first Policy Anniversary, and thereafter, which Section of the Policy Protection Account premium payments and loan repayments are allocated to depends on the accumulated value of the Policy Protection Account on the date of the payment: if the accumulated value in the Policy Protection Account is greater than zero, the premium payment or loan repayment is allocated to Section B; if the accumulated value in the Policy Protection Account is equal to or less than zero, the premium payment or loan repayment will be allocated to Section A.

The actual amount, timing and frequency of payments allocated to Section A and Section B will affect the accumulated values in the Policy Protection Account and could affect the availability of the benefit provided by this Rider. The Policy Protection Monthly Charge is calculated in the same manner as the Monthly Deduction Amount under the Policy (See the Monthly Deduction section of the Policy) but uses the Policy Protection Rider charges and rates that are set forth in the Policy Protection Rider Specifications Pages. The charges and rates used depends on the accumulated value in Section A. If, on any Monthly Activity Date, the accumulated value of Section A is zero, Schedule B charges and rates will be used. If, on any Monthly Activity Date, the accumulated value of Section A is greater than zero, Schedule A charges and rates will be used. The Policy Protection Monthly Charge will be first taken from Section A until the accumulated value in Section A becomes zero, with any remaining amount taken from Section B (Section B can become negative). Loans or Withdrawals deducted from the accumulated account value in the Policy Protection Account are taken first from Section A until the value in Section A is reduced to zero, with any remaining amount of loan or Withdrawal taken from Section B.

When calculating the policy protection cost of insurance charge, it is necessary to calculate the amount(s) at risk. When calculating the amount(s) at risk it is necessary to calculate the death benefit. The death benefit, for the purposes of calculating the amount(s) at risk is calculated in the same manner as the Policy s Death Benefit except that Account Value is replaced by the accumulated value in the Policy Protection Account. Additionally, when calculating the amount(s) at risk, the Account Value is replaced by the accumulated value in the Policy Protection Account.

A processor may provide the central processing unit (CPU) functions of a computing device on one or more integrated circuits. The term processor may include multi-core processors and central processing units including multiple microprocessors.

In embodiments, a processor may provide an output signal having data indicative of one or more data items. An output signal may be carried either over a suitable medium, such as wire or fiber, or wirelessly. An output signal may transmit data from one device to another directly, such as over a bus of a computer system from a processor to a memory device, or indirectly, such as over multiple networks, and with intermediate steps of storage in a buffer or memory device and retransmission. Such an output signal may be provided by the processor to a bus of a computer system together with address data at a series of clock intervals. The address data may designate a destination device on a bus, by way of example. In embodiments, an output signal may be a signal output from a hardware communications device of a computer system to a network, such as a local area network, a wide area network, or a network of interconnected networks, such as the Internet. Output signals may include, by way of example, data identifying formats, fields, and content of fields. Signals may be compatible with any appropriate format. For example, data may be formatted in accordance with a data format for insurance data, such as an ACORD compatible format. Reference to an output signal having particular data may include one or more signals bearing the information. Multiple signals bearing the information may include sequences of digital data bearing the information interleaved with sequences of digital data relating to other information. By way of example, a signal may be packetized for transmission. By way of further example, an output signal may take the form of an uncompressed digital signal or a compressed digital signal.

A system on which the methods of embodiments of the present invention may be implemented includes at least one central processing computer or computer network server. Network server includes at least one controller or central processing unit (CPU or processor), at least one communication port or hub, at least one random access memory (RAM), at least one read-only memory (ROM) and one or more databases or data storage devices. All of these later elements are in communication with the CPU to facilitate the operation of the network server. The network server may be configured in many different ways. For example, network server may be a conventional standalone server computer or alternatively, the function of server may be distributed across multiple computing systems and architectures.

Network server may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP.

Data storage device may include a hard magnetic disk drive, optical storage units, CD-ROM drives, or flash memory. Data storage devices contain databases used in processing transactions and/or calculations in accordance with embodiments of the present invention, including databases of cost of insurance rate information and interest rate information. In one embodiment, database software creates and manages these databases. Insurance related calculations and/or algorithms in accordance with an embodiment of the present invention are stored in storage device and executed by the CPU.

The controller comprises a processor, such as one or more conventional microprocessors and one or more supplementary co-processors such as math co-processors. The processor is in communication with a communication port through which the processor communicates with other devices such as other servers, user terminals or devices. The communication port may include multiple communication channels for simultaneous communication with, for example, other processors, servers or client terminals. As stated, devices in communication with each other need not be continually transmitting to each other. On the contrary, such devices need only transmit to each other as necessary, may actually refrain from exchanging data most of the time, and may require several steps to be performed to establish a communication link between the devices.

The processor also is in communication with a data storage device. The data storage device may comprise an appropriate combination of magnetic, optical and/or semiconductor memory, and may include, for example, RAM, ROM, flash drive, an optical disc such as a compact disc and/or a hard disk or drive. The processor and the data storage device each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wireline medium or combination of the foregoing.

The data storage device may store, for example, (i) a program (e.g., computer program code and/or a computer program product) adapted to or configured to direct the processor in accordance with embodiments of the present invention, and particularly in accordance with the processes described in detail hereinafter with regard to the controller; (ii) a database adapted to store information that may be utilized to store information required by the program. The program may be stored, for example, in a compressed, an uncompiled and/or an encrypted format, and may include computer program code. The instructions of the program may be read into a main memory of the processor from a non-transitory computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of embodiments of the present invention. Thus, embodiments of the present invention are not limited to any specific combination of hardware and software.

Suitable computer program code may be provided for performing numerous functions such as calculating a face value for the insurance product, calculating a suitable premium for the insurance policy, calculating a policy protection account value for the insurance product, and calculating a death benefit for the insurance product using the account value and the face value. The functions described above are merely exemplary and should not be considered exhaustive of the type of function which may be performed by the computer program code of embodiments of the present inventions.

The computer program code required to implement the above functions (and the other functions described herein) can be developed by a person of ordinary skill in the art, and is not described in detail herein.

A computing system may include modules, which may be implemented in hardware, software, or combinations of software and hardware, operably inter-connected via a bi-directional connection with a central serial bus or other bus. A system may include a display module and a generating module. The generating module is used for generating an insurance product contracts and other documents, which documents are then delivered to owners, insureds, beneficiaries, brokers, advisors and others, via any suitable hard copy or electronic method.

The computing system may be in communication with one or more payment systems for effecting payments to owners, insured and beneficiaries.

The term “computer-readable medium” as used herein refers to any medium that provides or participates in providing instructions to the processor of the computing device (or any other processor of a device described herein) for execution. Such a medium may take many forms, including but not limited to, non-volatile media, non-transitory media, tangible media, volatile media, and transmission media. Non-volatile media and tangible media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Servers of embodiments of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc).

An exemplary advantage of a method and system of the present invention is that the issuer of the policy may appropriately price a universal life insurance policy with a single pay premium, or limited number of payments at and shortly after issue of a policy, depending on the interest rate environment. The pricing may be changed easily responsive to changes in interest rate environment.

While particular embodiments of the invention have been illustrated and described in accordance with administration of insurance policies, various modifications and combinations can be made without departing from the spirit and scope of the invention, and all such modifications, combinations, and equivalents are intended to be covered and claimed.

What is claimed is:

1. A computer system for processing data related to an universal life insurance policy issued by an issuer to an owner and having a death benefit payable to a beneficiary on death of an insured, comprising:
a data storage device storing data indicative of rates and formulas applicable to the policy; and
a processor in communication with the data storage device, the processor configured to:
receive data indicative of, for an universal life insurance policy to be illustrated, an age of an insured, a death benefit amount, and timing of payment of premiums;
determine an amount of premiums required for the policy by determining whether a policy protection account will have a minimum balance at a selected future date at least 5 years after policy issue, the policy protection account balance being calculated by crediting to the policy protection account balance amounts of premiums, reduced by a first tier premium charge at a first rate up to a break point amount of premiums, and a second tier premium charge at a second rate above the break point amount of premiums, periodically crediting to the policy protection account an interest credit based on a policy protection account balance and an interest rate, and periodically deducting from the policy protection account balance cost of insurance charges based on death benefit amount;
generate an illustration for the policy including the determined amount of premiums, face value amount, and insured information, and
transmit via a data connection data indicative of the illustration.

2. The computer system of claim 1, wherein the timing of payments of premiums is a single premium payment for the policy.

3. The computer system of claim 1, wherein the timing of payments of premiums is in the nature of periodic level payments over a time period.

4. The computer system of claim 1, wherein the break point is based on cumulative payments over the life of the policy.

5. The computer system of claim 1, wherein the breakpoint is based on payments over a period of not more than five years.

6. The computer system of claim 1, wherein the second rate is dependent on a time of receipt of premium.

7. The computer system of claim 6, wherein the second rate is different from the first rate for premiums received in the first two to five years of the policy, and equal to the second rate for premiums received thereafter.

8. The computer system of claim 1, further comprising a policy issue computer system in communication with the processor, the policy issue computer system being configured to generate one or more policy documents consistent with the illustration for delivery to an insured to cause the policy to be issued.

9. The computer system of claim 1, further comprising an administrator computer system in communication with the data storage device, the administrator computer system configured to change data stored in the data storage device indicative of the second rate.

10. The computer system of claim 9, wherein the administrator computer system is configured to change the data stored in the data storage device indicative of the second rate automatically on a periodic basis.

11. The computer system of claim 9, wherein the administrator computer system is configured to change the data stored in the data storage device indicative of the second rate responsive to user input of a changed second rate.

12. A computer-implemented method for processing data related to an universal life insurance policy having a death benefit payable to a beneficiary on death of an insured, comprising:
receiving by a processor via a network data indicative of, for an universal life insurance policy to be illustrated, an age of an insured, a death benefit amount, and timing of payment of premiums;
accessing by the processor from a data storage device in communication with the processor data indicative of values of rates;
determining an amount of premiums required for the policy by determining whether a policy protection account will have a minimum balance at a selected future date at least 5 years after policy issue, the policy protection account balance being calculated by crediting to the policy protection account balance amounts of premiums, reduced by a first tier premium charge at a first rate up to a break point amount of premiums, and a second tier premium charge at a second rate above the break point amount of premiums, periodically crediting to the policy protection account an interest credit based on a policy protection account balance and an interest rate, and periodically deducting from the policy protection account balance cost of insurance charges based on death benefit amount;
generating by the processor an illustration for the policy including the determined amount of premiums, face value amount, and insured information, and
transmitting by the processor via a data connection data indicative of the illustration.

13. The computer-implemented method of claim 12, further comprising displaying the illustration on a user-accessible device.

14. The computer-implemented method of claim 12, wherein the user-accessible device is a smartphone for receiving the data indicative of the illustration via wireless communication.

15. The computer-implemented method of claim 12, further comprising a second break point corresponding to a value of premiums greater than the break point, and a third rate applicable to premiums above the second break point.

16. The computer-implemented method of claim 12, wherein the timing of payments is a single premium payment payable upon issue of the policy.

17. The computer-implemented method of claim 12, further comprising receiving data indicative of user selection of one or more riders, wherein the policy protection account balance is determined based on deducting a charge corresponding to each selected rider.

18. The computer-implemented method of claim 12, further comprising generating by a policy issue computer system in communication with the processor one or more policy documents consistent with the illustration for delivery to an insured to cause the policy to be issued.

19. The computer-implemented method of claim 12, further comprising changing, by an administrator computer system in communication with the data storage device, data stored in the data storage device indicative of the second rate.

20. The computer-implemented method of claim 19, wherein the changing is performed by the administrator computer system automatically on a periodic basis.

21. The computer system of claim 19, wherein the changing is performed by the administrator computer system responsive to user input of a changed second rate.

22. A computer system for processing data related to an universal life insurance policy having a death benefit, comprising:
a data storage device storing data indicative of a policy owner, an insured under the policy, a death benefit amount, payable under the policy to a beneficiary upon death of the insured, a schedule of premium payments, a formula for calculating a policy protection account balance, and values for use in the formula; and
a processor in communication with the data storage device, the processor configured to:
receive data indicative of an amount of a premium payment received with respect to the policy;
access from the data storage device a break point and at least a first rate for a first tier premium charge;
determine whether a second tier premium charge at a second rate is applicable to the premium payment;
responsive to determining that the second tier premium charge is applicable, determine a charge using the second rate for premium amounts above the break point, and
store the calculated credit to the policy protection account in the memory storage device.

23. The computer system of claim 22, wherein the break point is based on cumulative premium payments over the life of the policy.

24. The computer system of claim 22, wherein the break point is based on premium payments over a period of not more than five years.

25. The computer system of claim 22, wherein the second rate is dependent on a time of receipt of premium.

26. The computer system of claim 22, further comprising a policy issue computer system in communication with the processor, the policy issue computer system being configured to generate one or more policy documents associated with the policy for delivery to the policy owner.

27. The computer system of claim 22, further comprising an administrator computer system in communication with the data storage device, the administrator computer system configured to change data stored in the data storage device indicative of the second rate.

28. A computer-implemented method for processing data related to a universal life insurance policy, comprising:
receiving by a processor data indicative of an amount of a premium payment received with respect to the policy;
accessing by the processor from a data storage device in communication with the processor a break point and at least a first rate for a first tier premium charge;
determining by the processor whether a second tier premium charge at a second rate is applicable to the premium payment;
responsive to determining that the second tier premium charge is applicable, determining by the processor a charge using the second rate for premium amounts above the break point, and
storing by the processor the calculated credit to the policy protection account in the memory storage device.

29. The computer-implemented method of claim 28, wherein the break point is based on cumulative premium payments over the life of the policy.

30. The computer-implemented method of claim 28, wherein the breakpoint is based on payments over a period of not more than five years.

31. The computer-implemented method of claim 28, further comprising generating by a policy issue computer system in communication with the processor one or more policy documents associated with the policy for delivery to the policy owner.

32. The computer-implemented method of claim 28, further comprising changing, by an administrator computer system in communication with the data storage device, data stored in the data storage device indicative of the second rate.
